(19) United States
(12) Patent Application Publication
(10) Pub. No.: US 2017/0060783 A1
(43) Pub. Date: Mar. 2, 2017

(54) APPARATUS FOR PERFORMING SECURE MEMORY ALLOCATION CONTROL IN AN ELECTRONIC DEVICE, AND ASSOCIATED METHOD

(71) Applicant: MEDIATEK INC., Hsin-Chu (TW)

(72) Inventors: Sheng-Yu Chiu, Kaohsiung City (TW); Ching-Fu Kung, Taoyuan City (TW); Chih-Pin Su, Hsinchu City (TW); Ming-Hsien Hsieh, New Taipei City (TW)

(21) Appl. No.: 15/064,601

(22) Filed: Mar. 9, 2016

Related U.S. Application Data
(60) Provisional application No. 62/213,095, filed on Sep. 1, 2015.

(51) Int. Cl. G06F 12/14; G06F 12/10; G06F 3/06

(52) U.S. Cl. CPC G06F 12/1483; G06F 3/0623; G06F 3/0653; G06F 3/0673; G06F 12/1408; G06F 12/1009; G06F 2212/1052

(57) ABSTRACT

An apparatus for performing secure memory allocation control in an electronic device and an associated method are provided. The electronic device may include a plurality of bus master circuits, each of which has capability of accessing data through a bus of the electronic device, and may further include a plurality of master side memory address filters (MAFs) that are coupled between the bus and the bus master circuits, where the apparatus may include a control circuit that is coupled to the master side MAFs. In addition, the control circuit may be arranged for controlling secure memory allocation of the electronic device through the master side MAFs, to restrict any unauthorized access to any portion of secure data within the electronic device. Additionally, the master side MAFs may be arranged for selectively restricting data accessing activities of the bus master circuits through memory address filtering.

### CROSS REFERENCE TO RELATED APPLICATIONS

This application claims the benefit of U.S. Provisional Application No. 62/213,095, which was filed on Sep. 1, 2015, and is included herein by reference.

### BACKGROUND

The present invention relates to on demand secure memory allocation of a portable electronic device, and more particularly, to an apparatus for performing secure memory allocation control in an electronic device, and an associated method.

According to the related art, a conventional portable electronic device such as a conventional multifunctional mobile phone may be equipped with limited memory resources. As a conventional application running on the conventional portable electronic device may demand a great amount of secure memory space from the limited memory resources, some problems may occur. For example, the great amount of secure memory space may reach 1.9 gigabytes (GB) (e.g. for a purpose of supporting protected video playback corresponding to an ultra high definition (UHD)) while the total size of the random access memory (RAM) of the conventional portable electronic device may be only a few GB (e.g. 2 GB or 3 GB, in some products that are available). Some conventional methods are proposed to try resolving these problems. However, further problems such as some side effects may be introduced. Thus, a novel architecture is required to guarantee the overall performance of the electronic device.

### SUMMARY

It is an objective of the claimed invention to provide an apparatus for performing secure memory allocation control in an electronic device, and an associated method, in order to solve the above-mentioned problems.

It is another objective of the claimed invention to provide an apparatus for performing secure memory allocation control in an electronic device, and an associated method, in order to guarantee the overall performance of the electronic device.

According to at least one preferred embodiment, an apparatus for performing secure memory allocation control in an electronic device is provided, where the apparatus may comprise at least one portion (e.g. a portion or all) of the electronic device. In addition, the apparatus may comprise a control circuit that is positioned in the electronic device and is coupled to a plurality of master side memory address filters (MAFs) in the electronic device, and the control circuit may be arranged for controlling secure memory allocation of the electronic device through maintaining memory address filtering information for the master side MAFs, to make the master side MAFs restrict any unauthorized access to any portion of secure data within the electronic device. Additionally, a plurality of bus master circuits in the electronic device are arranged for performing operations for the electronic device, and each of the bus master circuits has capability of accessing data through a bus of the electronic device. Further, the master side MAFs are coupled between the bus and the bus master circuits, respectively, and are arranged for selectively restricting data accessing activities of the bus master circuits through memory address filtering according to the memory address filtering information. For example, the apparatus may comprise the bus master circuits. In another example, the apparatus may comprise the master side MAFs. In another example, the apparatus may comprise the bus master circuits and the master side MAFs.

According to at least one preferred embodiment, a method for performing secure memory allocation control in an electronic device is provided, where the method may comprise: controlling secure memory allocation of the electronic device through maintaining memory address filtering information for a plurality of master side memory address filters (MAFs) in the electronic device, to make the master side MAFs restrict any unauthorized access to any portion of secure data within the electronic device. In addition, a plurality of bus master circuits in the electronic device are arranged for performing operations for the electronic device, and each of the bus master circuits has capability of accessing data through a bus of the electronic device. Additionally, the master side MAFs are coupled between the bus and the bus master circuits, respectively, and are utilized for selectively restricting data accessing activities of the bus master circuits through memory address filtering according to the memory address filtering information. For example, the method may comprise: utilizing the master side MAFs to selectively restrict the data accessing activities of the bus master circuits through memory address filtering.

According to at least one preferred embodiment, an apparatus for performing secure memory allocation control in an electronic device is provided, where the apparatus may comprise at least one portion (e.g. a portion or all) of the electronic device. In addition, the apparatus may comprise a control circuit that is positioned in the electronic device and is coupled to a memory region filter table in the electronic device, and the control circuit may be arranged for controlling secure memory allocation of the electronic device through maintaining memory address filtering information for the memory region filter table, to restrict any unauthorized access to any portion of secure data within the electronic device. In addition, a plurality of bus master circuits in the electronic device are arranged for performing operations for the electronic device, and each of the bus master circuits has capability of accessing data through a bus of the electronic device. Additionally, with aid of the memory region filter table, the control circuit is arranged for selectively restricting data accessing activities of the bus master circuits through memory address filtering according to the memory address filtering information. Further, the memory region filter table comprises a plurality of sets of permission bits respectively corresponding to a plurality of sections of data, wherein each set of the plurality of sets of permission bits corresponds to a plurality of permission bit fields indicating different types of permission.

It is an advantage of the present invention that the present invention apparatus and method can keep high stability of the electronic device in each of various situations, and the related art problems will no longer be an issue. In addition, the present invention apparatus and method can guarantee the overall performance of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing secure memory allocation control in an electronic device according to an embodiment of the present invention.

FIG. 2 is a flowchart of a method for performing secure memory allocation control in an electronic device according to an embodiment of the present invention.

FIG. 3 illustrates a MAF control scheme involved with the method shown in FIG. 2 according to an embodiment of the present invention.

FIG. 4 illustrates an enhanced MAF (EMAF) control scheme involved with the method shown in FIG. 2 according to an embodiment of the present invention.

FIG. 5 illustrates a MAF plus MPU (MAF-MPU) control scheme involved with the method shown in FIG. 2 according to an embodiment of the present invention.

FIG. 6 illustrates a memory reservation flow of the MAF-MPU control scheme shown in FIG. 5 according to an embodiment of the present invention.

FIG. 7 illustrates a memory return flow of the MAF-MPU control scheme shown in FIG. 5 according to an embodiment of the present invention.

FIG. 8 illustrates a two-stage memory management unit (MMU) plus MAF plus MPU (2-stage-MMU-MAF-MPU) control scheme involved with the method shown in FIG. 2 according to an embodiment of the present invention.

FIG. 9 illustrates a memory reservation flow of the 2-stage-MMU-MAF-MPU control scheme shown in FIG. 8 according to an embodiment of the present invention.

FIG. 10 illustrates a memory return flow of the 2-stage-MMU-MAF-MPU control scheme shown in FIG. 8 according to an embodiment of the present invention.

FIG. 11 illustrates a fast data exchange flow involved with the method shown in FIG. 2 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

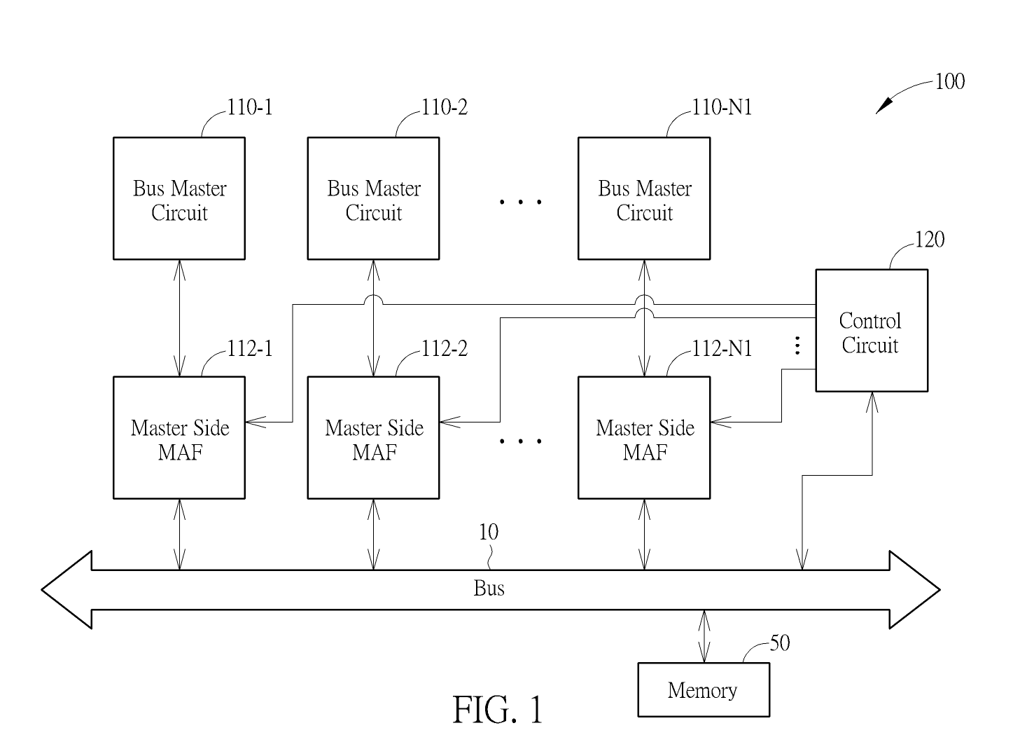

FIG. 1 is a diagram of an apparatus 100 for performing secure memory allocation control in an electronic device according to an embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wired or wireless communications system comprising the electronic device). Examples of the electronic device may include, but not limited to, a mobile phone (e.g. a multifunctional mobile phone), a tablet, and a personal computer (PC) such as a laptop computer or a desktop computer.

According to this embodiment, the electronic device may comprise a bus 10, a memory 50, and a plurality of bus master circuits such as N1 bus master circuits 110-1, 110-2, . . . , and 110-N1 (e.g. the notation N1 may represent a positive integer, such as a integer greater than one), where the plurality of bus master circuits may be arranged for performing operations for the electronic device, and each of the bus master circuits has capability of accessing data (e.g. accessing data in the memory 50) through the bus 10 of the electronic device. For better comprehension, all of the bus 10, the memory 50, and the bus master circuits 110-1, 110-2, . . . , and 110-N1 may be illustrated within the apparatus 100. This is for illustrative purposes only, and is not meant to be a limitation of the present invention. According to some embodiments of the present invention, it is unnecessary that all of the bus 10, the memory 50, and the bus master circuits 110-1, 110-2, . . . , and 110-N1 are positioned within the apparatus 100. For example, the bus 10 and/or the memory 50 may be positioned outside the apparatus 100. More particularly, the bus 10 and the memory 50 may be positioned outside the apparatus 100 in one of these embodiments. In addition, the bus 10 may be positioned outside the apparatus 100 in another of these embodiments. Additionally, the memory 50 may be positioned outside the apparatus 100 in yet another of these embodiments.

As shown in FIG. 1, the apparatus 100 may comprise the bus master circuits 110-1, 110-2, . . . , and 110-N1 (which can also be referred to as the bus masters, for brevity), a plurality of master side memory address filters (MAFs) positioned in the electronic device, such as N1 master side MAFs 112-1, 112-2, . . . , and 112-N1, and a control circuit 120 positioned in the electronic device, where the master side MAFs 112-1, 112-2, . . . , and 112-N1 are coupled between the bus 10 and the bus master circuits 110-1, 110-2, . . . , and 110-N1, respectively, and the control circuit 120 is coupled to the master side MAFs 112-1, 112-2, . . . , and 112-N1. For better comprehension, the control circuit 120 and the bus master circuits 110-1, 110-2, . . . , and 110-N1 may be respectively illustrated. This is for illustrative purposes only, and is not meant to be a limitation of the present invention. According to some embodiments, the control circuit 120 may be integrated into one of the plurality of bus master circuits, such as one of the bus master circuits 110-1, 110-2, . . . , and 110-N1. For example, the aforementioned one of the plurality of bus master circuits may be a processor of the electronic device. In some examples, one or more of the plurality of bus master circuits may be a processor of the electronic device or any other type of control unit or circuit. According to some embodiments, in addition to the bus master circuits 110-1, 110-2, . . . , and 110-N1, the plurality of bus master circuits may further comprise another bus master circuit that is utilized as the control circuit 120. According to some embodiments, the master side MAFs 112-1, 112-2, . . . , and 112-N1 may be integrated into the control circuit 120. For example, the master side MAFs 112-1, 112-2, . . . , and 112-N1 may be utilized for filtering transactions on the bus. More particularly, the master side MAFs 112-1, 112-2, . . . , and 112-N1 may be implemented with hardware circuits, and at least one processor in the electronic device and the master side MAFs 112-1, 112-2, . . . , and 112-N1 may be integrated into the same module, which may be referred to as the control circuit 120 of these embodiments, where some program modules running on the at least one processor may control the master side MAFs 112-1, 112-2, . . . , and 112-N1. This is for illustrative purposes only, and is not meant to be a limitation of the present invention. For example, the architecture for filtering bus transactions (i.e. transactions on the bus) may vary.

For better comprehension, all of the control circuit 120, the master side MAFs 112-1, 112-2, . . . , and 112-N1, and the bus master circuits 110-1, 110-2, . . . , and 110-N1 may be illustrated within the apparatus 100. This is for illustrative purposes only, and is not meant to be a limitation of the present invention. According to some embodiments of the present invention, it is unnecessary that all of the control circuit 120, the master side MAFs 112-1, 112-2, . . . , and 112-N1, and the bus master circuits 110-1, 110-2, . . . , and 110-N1 are positioned within the apparatus 100. For example, the master side MAFs 112-1, 112-2, . . . , and 112-N1 and/or the bus master circuits 110-1, 110-2, . . . , and 110-N1 may be positioned outside the apparatus 100. More particularly, the master side MAFs 112-1, 112-2, . . . , and 112-N1 and the bus master circuits 110-1, 110-2, . . . , and 110-N1 may be positioned outside the apparatus 100 in one of these embodiments. In addition, the master side MAFs 112-1, 112-2, . . . , and 112-N1 may be positioned outside the apparatus 100 in another of these embodiments. Additionally, the bus master circuits 110-1, 110-2, . . . , and 110-N1 may be positioned outside the apparatus 100 in yet another of these embodiments.

According to some embodiments, applications of smart phones or tablet PCs may need to be executed in an isolated and secured environment, e.g. Payment and DRM (Digital Right Management). A bus master may be a device which has the ability to issue bus transactions to access an external memory, where examples of the bus masters may include, but not limited to, processors, crypto engines, and video decoders. For example, each of the bus masters may provide two types of device registers, such as normal registers that can be accessed by normal bus transaction, and secure registers that can be accessed by secure bus transaction only. When the bus master receives a job from secure registers, it will start the secure job and may issue a series of secure bus transactions. For example, a memory protection unit (MPU) may be implemented for filtering out illegal memory access according to bus transaction modes and the filter table configurations. According to some embodiments, a processor may have two execution environments, such as one called the first world and another called the second world. A processor in the electronic device is capable of executing a plurality of programs (e.g. applications), and each program that is selected from the plurality of programs and runs on the processor is allowed to access data in the first world, but may be prohibited from accessing data in the second world. For example, each program that is selected from a portion of the plurality of programs and runs on the processor is allowed to access data in the second world, and each program that is selected from another portion of the plurality of programs and runs on the processor is prohibited from accessing data in the second world. According to some embodiments, the ARM TrustZone® technology may be applied to the electronic device, and the associated functionality may be enabled, where a processor may have two execution environments, such as one called the normal world and another called the secure world, where the normal world can be taken as an example of the first world, and the secure world can be taken as an example of the second word. When a processor executes a program in the normal world, it always issues normal bus transactions to access external memory or device registers; and when executing a program in the secure world, the processor can issue normal or secure bus transactions. In addition, software programs running on a processor can control other bus masters to issue normal or secure bus transactions by accessing the normal or secure only registers of a bus master. For example, a DRM software executed in secure world on a processor can decrypt a secure video content stored in a secure memory region via a crypto engine by sending a decrypt command and the memory address of the secure video content to the specific secure registers, and when the crypto engine receives the command, it will start accessing the secure video content by issuing secure memory access bus transactions and then decrypt the content.

As supporting high resolution (4K/8K UHD) DRM is more and more important on smart phones and tablet devices, this feature results in secure memory space requirement increased largely from 16 megabytes (MB) or 32 MB to almost 2 GB. However, it is not very often to play DRM video for most of the smart phone or tablet users. According to some embodiments, it is workable to allocate the memory from normal memory regions for the secure application which may need large memory space and to return those on-demand secure memory regions back to normal memory regions when the operation of the secure application is finished. For example, it is an option to implement a normal world software (such as a Linux kernel driver) that is responsible for allocating and reserving a number of small memory regions from existing normal memory regions, and then notifying a secure memory management software to configure a memory region filter table to mark the small memory regions as secure memory. Although a memory protection unit (MPU) may be utilized for implementing a very powerful filter, in realistic the number of filter table entries (within the memory region filter table) that are implemented with the MPU may be very limited due to a limited budget (or cost) of the MPU. In general the filter table is programmed at boot time and will not be changed dynamically.

Based on the architecture shown in FIG. 1, the problem of the limited number of filter table entries implemented with the MPU will no longer be an issue since the master side MAFs 112-1, 112-2, . . . , and 112-N1 may be utilized for filtering transactions of the bus master circuits 110-1, 110-2, . . . , and 110-N1, respectively. For example, the control circuit 120 may be implemented with multiple program modules running on the processor of the electronic device, and the master side MAFs 112-1, 112-2, . . . , and 112-N1 may be implemented with pure hardware circuits. In some embodiments, the program modules may comprise one or more drivers adapted to an operating system (OS).

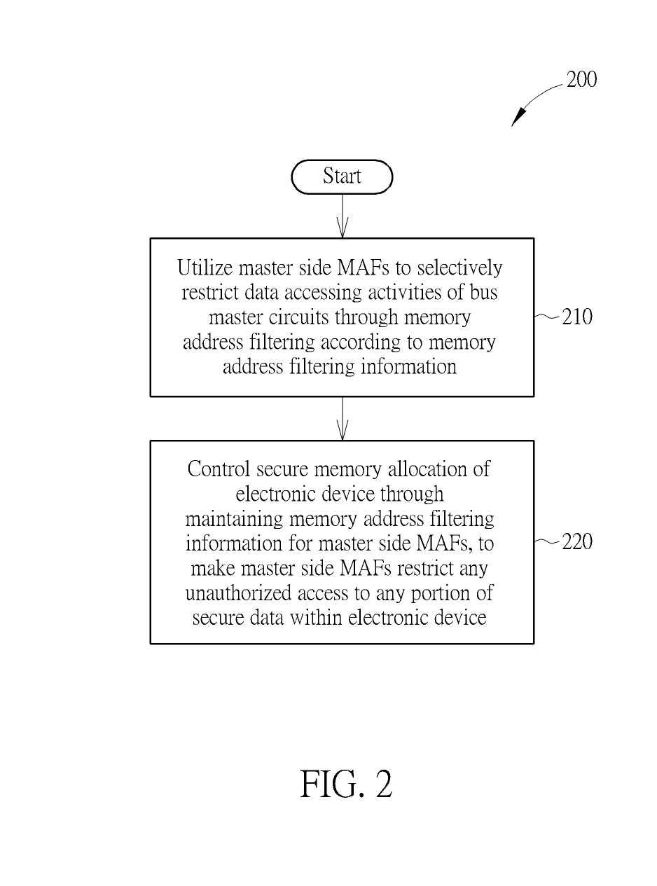

FIG. 2 is a flowchart of a method 200 for performing secure memory allocation control in an electronic device according to an embodiment of the present invention. The method 200 shown in FIG. 2 can be applied to the apparatus 100 shown in FIG. 1, and can be applied to the control circuit 120 mentioned above, no matter whether the control circuit 120 is positioned outside the plurality of bus master circuits such as the bus master circuits 110-1, 110-2, . . . , and 110-N1 of the embodiment shown in FIG. 2 or is integrated into the aforementioned one of the plurality of bus master circuits.

In Step 210, the control circuit 120 may utilize the master side MAFs 112-1, 112-2, . . . , and 112-N1 to selectively restrict data accessing activities of the bus master circuits 110-1, 110-2, . . . , and 110-N1 through memory address filtering according to memory address filtering information. According to some embodiments, the apparatus 100 may further store at least one permission table (e.g. one or more permission tables, not shown in FIG. 1 and FIG. 2) that is coupled to the control circuit 120 and the master side MAFs 112-1, 112-2, . . . , and 112-N1, where the permission table may be arranged for providing the master side MAFs 112-1, 112-2, . . . , and 112-N1 with the memory address filtering information for memory address filtering regarding the bus master circuits 110-1, 110-2, . . . , and 110-N1, respectively. For example, the master side MAFs 112-1, 112-2, . . . , and 112-N1 may selectively restrict the data accessing activities of the bus master circuits 110-1, 110-2, . . . , and 110-N1 through memory address filtering based on the permission table, respectively. This is for illustrative purposes only, and is not meant to be a limitation of the present invention. According to some embodiments, the permission table may indicate whether a plurality of memory regions of the memory 50 are accessible. For example, based on the permission table, each of the master side MAFs 112-1, 112-2, . . . , and 112-N1 (e.g. the master side MAF 112-n0, where the notation “n0” may represent a positive integer falling within the range of the interval [1, N1]) may determine whether the corresponding bus master circuit within the bus master circuits 110-1, 110-2, . . . , and 110-N1 (e.g. the bus master circuit 110-n0) is allowed to access the memory regions of the memory 50, respectively, and selectively restrict the data accessing activities of the corresponding bus master circuit (e.g. the bus master circuit 110-n0), such as the data accessing activities regarding the memory regions of the memory 50, respectively. According to some embodiments, the control circuit 120 may control, amend, update or manage contents of the permission table for memory address filtering regarding the bus master circuits 110-1, 110-2, . . . , and 110-N1, respectively, where the contents of the permission table may comprise the memory address filtering information. For example, the control circuit 120 may update the contents of the permission table for memory address filtering regarding the bus master circuits 110-1, 110-2, . . . , and 110-N1, respectively.

In Step 220, the control circuit 120 may control secure memory allocation of the electronic device through maintaining the memory address filtering information for the master side MAFs 112-1, 112-2, . . . , and 112-N1, to make the master side MAF 112-1, 112-2, . . . , and 112-N1s restrict any unauthorized access to any portion of secure data within the electronic device. According to some embodiments, the master side MAFs 112-1, 112-2, . . . , and 112-N1 may obtain the memory address filtering information from the aforementioned at least one permission table (e.g. one or more permission tables), which may be maintained by the control circuit 120, for memory address filtering regarding the bus master circuits 110-1, 110-2, . . . , and 110-N1, respectively. For example, according to the memory address filtering information in the aforementioned at least one permission table, the master side MAFs 112-1, 112-2, . . . , and 112-N1 may determine whether an access to the portion of secure data is the unauthorized access to the portion of secure data.

Please note that the operation of Step 210 and the operation of Step 220 are respectively illustrated in FIG. 2. This is for illustrative purposes only, and is not meant to be a limitation of the present invention. According to some embodiments, at least one portion (e.g. a portion or all) of the operation of Step 210 and at least one portion (e.g. a portion or all) of the operation of Step 220 can be performed at the same time. According to some embodiments, at least one portion (e.g. a portion or all) of the operation of Step 210 and/or at least one portion (e.g. a portion or all) of the operation of Step 220 can be performed repeatedly. According to some embodiments, at least one portion (e.g. a portion or all) of the operation of Step 210 may be performed after at least one portion (e.g. a portion or all) of the operation of Step 220 is performed. For example, some initial values within the aforementioned at least one permission table may be maintained by the control circuits, where the memory address filtering information may comprise these initial values. This is for illustrative purposes only, and is not meant to be a limitation of the present invention. For example, the initial values within the aforementioned at least one permission table may be preloaded during a manufacturing phase of the electronic device.

According to some embodiments, the control circuit 120 may comprise a memory reservation service (MRS) module and a memory protection service (MPS) module (which can be referred to as the MRS and the MPS, respectively, for brevity). For example, the MRS module and the MPS module may be implemented with program modules running on at least one processor of the electronic device, such as the aforementioned processor of the electronic device. This is for illustrative purposes only, and is not meant to be a limitation of the present invention. For example, the MRS module and/or the MPS module may be implemented with pure hardware circuits when needed. According to some embodiments, the method 200 may further comprise utilizing the MRS module to reserve a plurality of memory regions in a normal memory world, which may also be referred to as the normal world, for brevity. In addition, the method 200 may further comprise utilizing the MPS module to reclaim at least one portion of the memory regions as secure memory regions in a secure memory world, which may also be referred to as the secure world, for brevity. For example, the aforementioned at least one portion of the memory regions may be reclaimed as the secure memory regions by configuring at least one permission table (e.g. one or more permission tables) such as that mentioned above. In one of these embodiments, the aforementioned at least one permission table may comprise a single permission table, such as a MAF page permission table. In another of these embodiments, the aforementioned at least one permission table may comprise multiple permission tables, such as the MAF page permission table and a stage-two (stage2) memory management unit (MMU) page table (which can also be referred to as the stage2 page table, for brevity). According to some embodiments, implementation of the MPS module may be in the secure world only, or may be separated in the highest execution level in the normal world and in the secure world.

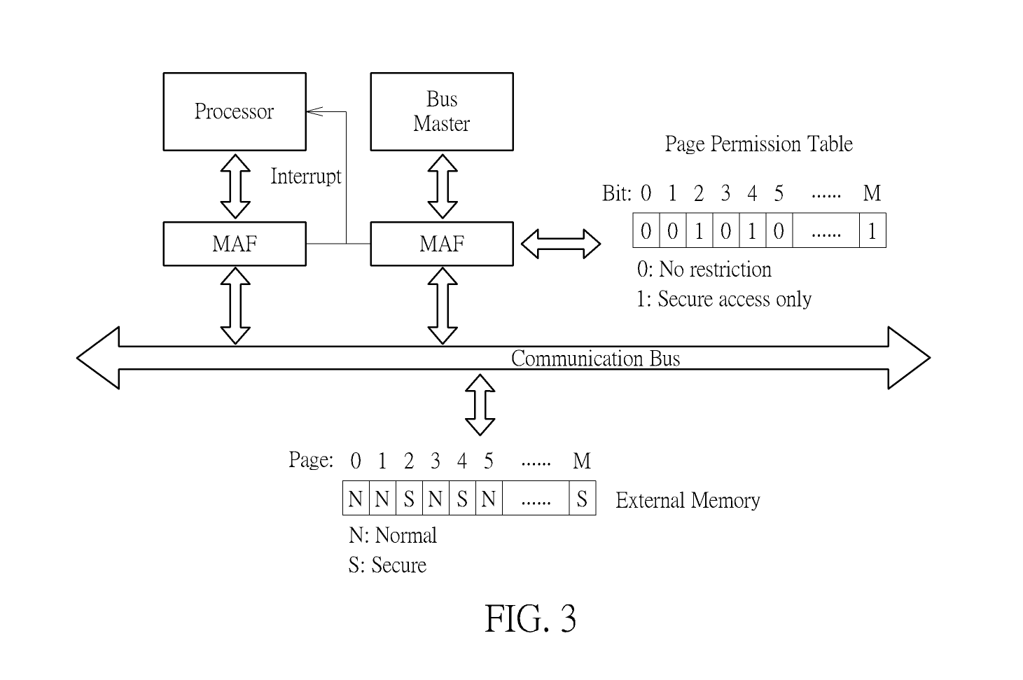

FIG. 3 illustrates a MAF control scheme involved with the method 200 shown in FIG. 2 according to an embodiment of the present invention. The external memory space can be represented as, for example but not a limitation, a number of pages with the same size. When a MAF such as one of the master side MAFs 112-1, 112-2, . . . , and 112-N1 (which can also be referred to as the MAFs, for brevity) receives a memory access bus transaction, this MAF may calculate the page number from the associated memory address and utilize the page number as the index to get page permission, which is given according to the page permission table. If a normal bus transaction tries to access a page with secure-access-only permission, this MAF may treat this bus transaction as an illegal access. In addition, the size of the page permission table may depend on the external memory size and the MAF page size. Assuming that the external memory size is 4096 MB and the MAF page size is 1 MB, the number of bits for respectively indicating the statuses of the pages can be expressed as follows:

(4096 MB)/(1 MB)=4096;

which means, the minimum size of the page permission table is 4 kilobytes (KB). In some embodiments, the MAFs may be designed to have the ability to do extra works when one of the bits in the page permission table is changed. For example, the MAFs may clear data that previously exist in one of the memory regions if the corresponding permission bit is changed (for example, from 0 to 1, or from 1 to 0). Such clear data function can help to reduce software efforts and improve performance. After data clear is done, the MAFs may notify the control circuit 120 such as that implemented with the associated software running on the processor by an interrupt, or wait for the associated software to read statuses from specific registers.

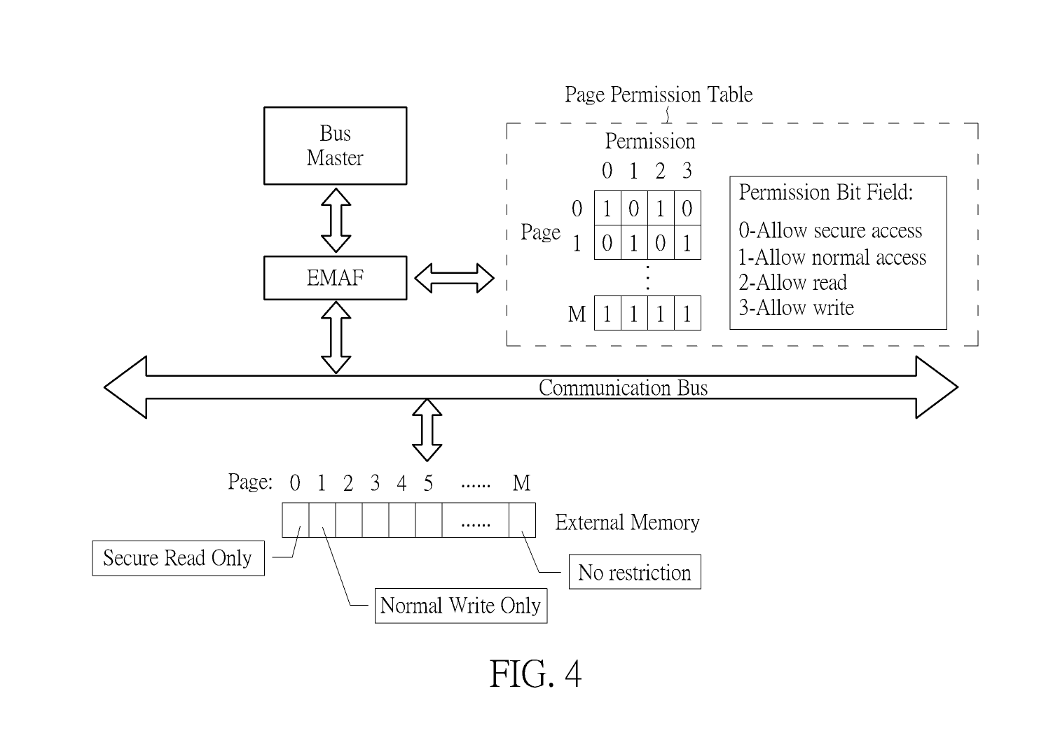

FIG. 4 illustrates an enhanced MAF (EMAF) control scheme involved with the method 200 shown in FIG. 2 according to an embodiment of the present invention. In comparison with the MAF control scheme, in which the MAF page permission can only be no restriction or secure access only, an EMAF that replaces one of the MAFs may provide more flexibility. According to this embodiment, the permission for each page in the EMAF may be defined by more than one bit, so the memory protection policy design flexibility may be increased. In addition, the page permission table format of the page permission table shown in FIG. 4 allows 9 permission combinations for each page, where some of the permission combinations may be redundant. For example, each set of the sets of permission bits 00xx and xx00 means that the page access is blocked.

According to some embodiments, such as that shown in FIG. 4, the contents of the page permission table may comprise a plurality of sets of permission bits respectively corresponding to a plurality of pages of data (e.g. Page 0 through to Page M), where each set of the plurality of sets of permission bits may correspond to a plurality of permission bit fields indicating different types of permission, such as Field 0 indicating whether to allow secure access, Field 1 indicating whether to allow normal access, Field 2 indicating whether to allow reading, and Field 3 indicating whether to allow writing. As shown in FIG. 4, according to the set of permission bits 1010 corresponding to Page 0, the EMAF allows secure access to Page 0 and allows reading Page 0 (labeled “Secure Read Only” in FIG. 4). In addition, according to the set of permission bits 0101 corresponding to Page 1, the EMAF allows normal access to Page 1 and allows writing Page 1 (labeled “Normal Write Only” in FIG. 4). Additionally, according to the set of permission bits 1111 corresponding to Page M, the EMAF allows secure access and normal access to Page M and allows reading and writing Page M (labeled “No restriction” in FIG. 4). This is for illustrative purposes only, and is not meant to be a limitation of the present invention. According some embodiments, the contents of the page permission table (e.g. the permission bits therein) may vary.

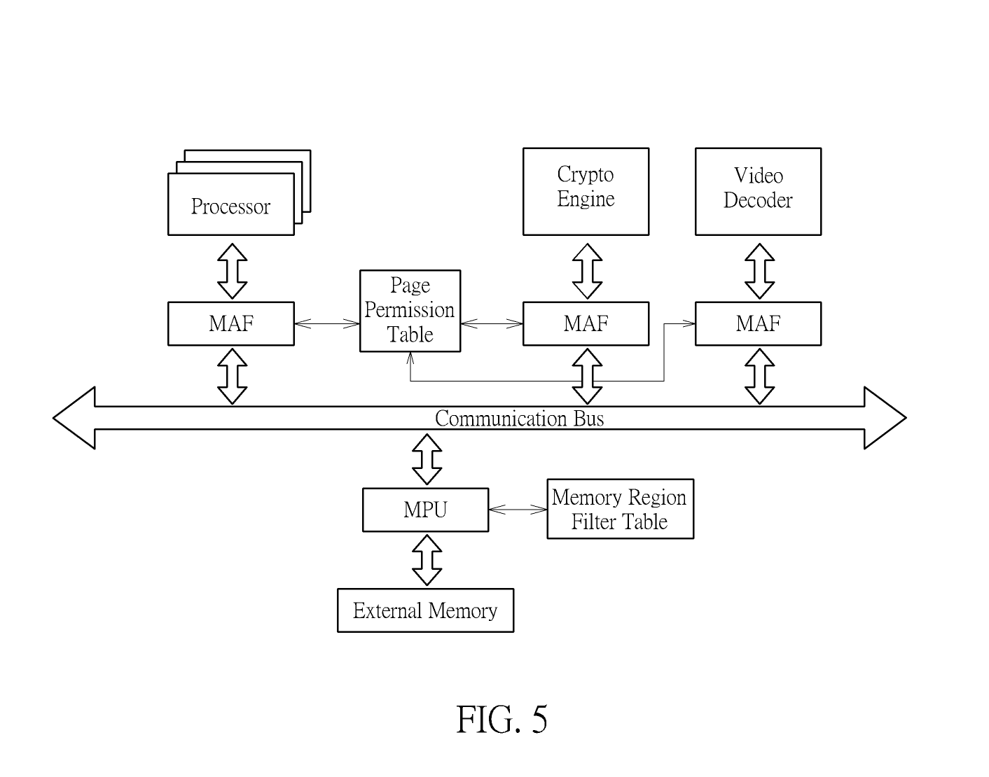

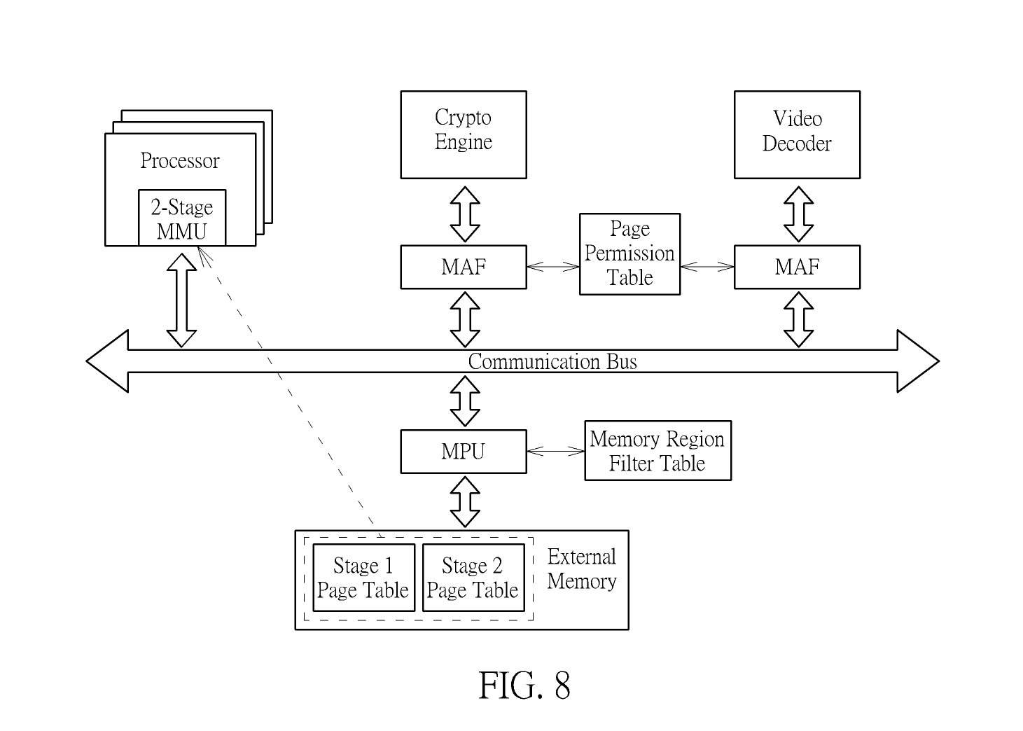

Based on the architecture shown in FIG. 1, the apparatus 100 that operates according to the method 200 may perform on-demand secure memory allocation. According to some embodiments, different control schemes may be applied to achieve the goal of runtime secure memory allocation, respectively. For example, a solution such as that of the embodiment shown in FIG. 5 may use the MAFs and an MPU(s) to protect secure memory (e.g. the memory space in the secure world) from being accessed illegally by all bus masters, and another solution such as that of the embodiment shown in FIG. 8 may use a two-stage (2-stage) MMU, the MAFs and an MPU to protect secure memory. Please note that, in some embodiments, the MAFs mentioned in the two solutions can be replaced by EMAFs.

FIG. 5 illustrates a MAF plus MPU (MAF-MPU) control scheme involved with the method 200 shown in FIG. 2 according to an embodiment of the present invention. Based on the MAF-MPU control scheme, the MAFs may be added in between each of the bus masters and the bus 10 such as the communication bus, and all of the MAFs may share the same page permission table. In this embodiment, assuming that the external memory size of the system is 4096 MB, the MAF page size may be 8 MB, and initially 32 MB memory space may be reserved for secure access only by configuring the MPU memory region filter table, i.e. the memory region filter table coupled to the memory protection unit (MPU) shown in FIG. 5.

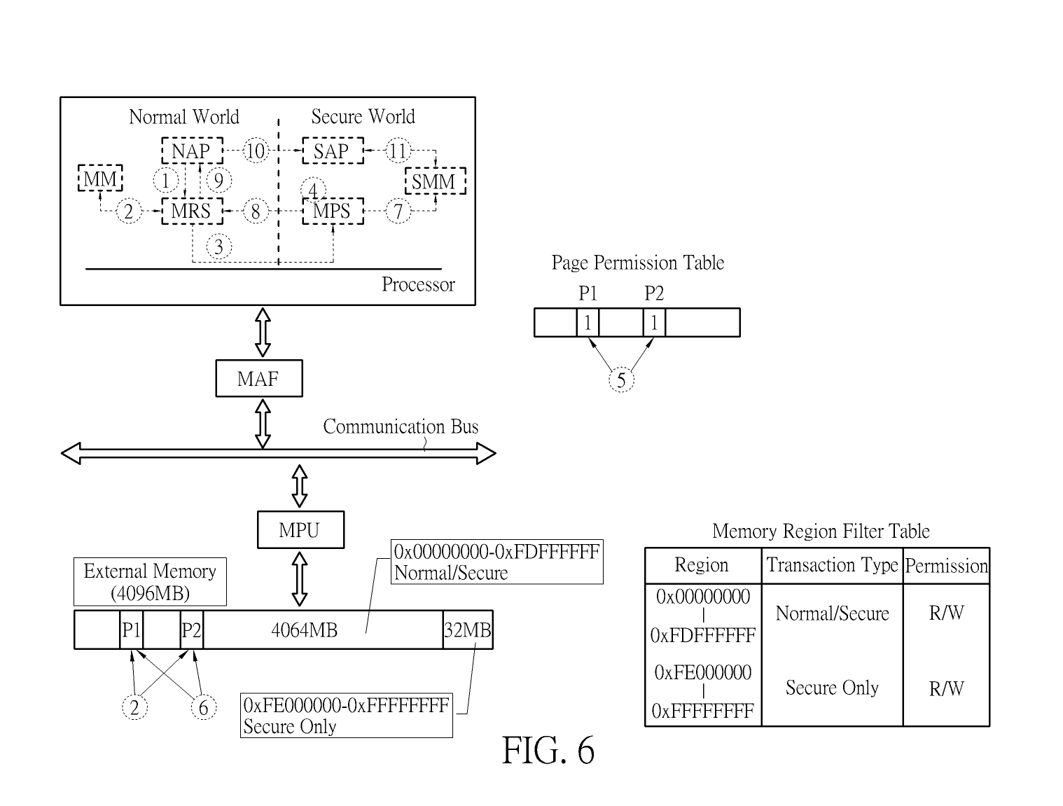

FIG. 6 illustrates a memory reservation flow of the MAF-MPU control scheme shown in FIG. 5 according to an embodiment of the present invention, where the numbers 1 through to 11 labeled in the small circles shown in FIG. 6 may represent Step S1-1 through to Step S1-11, respectively. For example, when a secure world application needs 16 MB (which is equivalent to 2 MAF pages) memory spaces in addition to the 32 MB secure memory, the apparatus 100 may request memory space by the following steps:

(S1-1). The normal world application (NAP) sends a memory reservation request to the MRS executed in the normal world to reserve 2 MAF pages in normal memory region.
(S1-2). After receiving the request, the MRS starts to request 2 available MAF pages from the normal world memory management service (MM).
(S1-3). The MRS sends “Add Protection” message containing the reserved MAF page numbers to the MPS executed in the secure world and waits for response.
(S1-4). After receiving the “Add Protection” message, the MPS starts to check whether the page number is valid or not. If valid, it may keep the page numbers in the page reservation list.
(S1-5). The MPS modifies the page permission table and marks the MAF pages as “secure access only”.
(S1-6). The MPS starts to clean memory contents of the pages.
(S1-7). The MPS notifies the secure world memory management service (SMM) to add the reserved memory space to the secure world memory pool.
(S1-8). The MPS responses a success message to the MRS.
(S1-9). After the MRS receives the success response message, it returns a success return code to the normal world application.
(S1-10). After the normal world application receives success return code, it starts to invoke the secure world application (SAP) to do the secure jobs.
(S1-11). The secure world application now can request enough memory space from SMM.

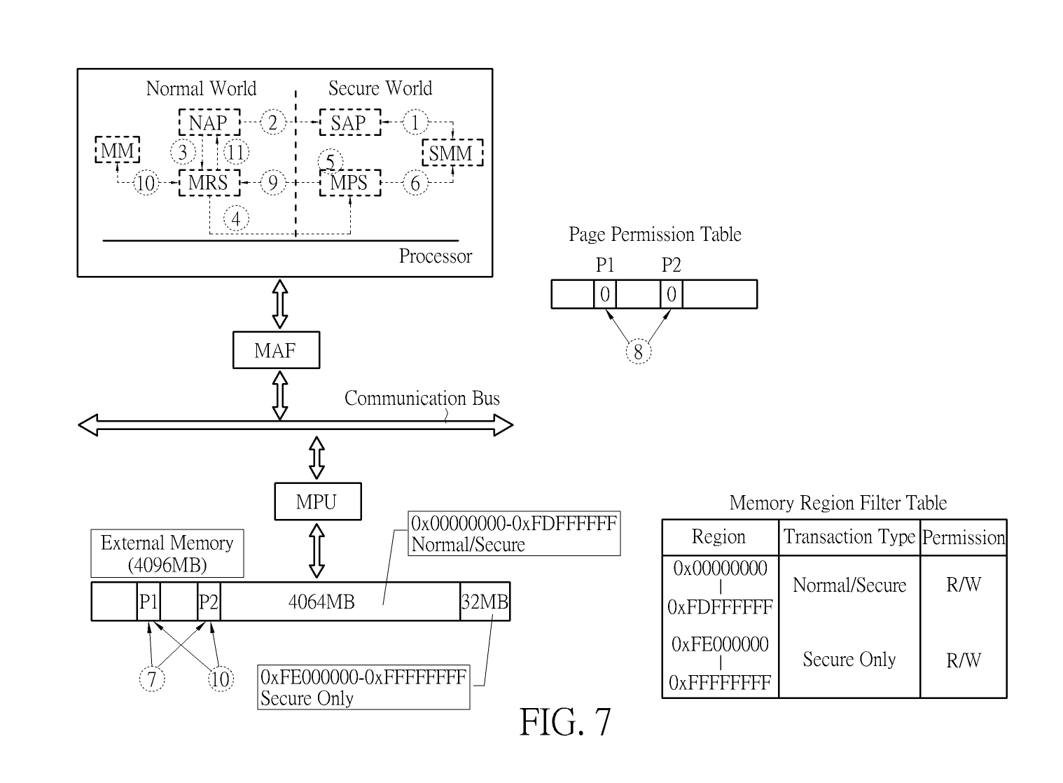

FIG. 7 illustrates a memory return flow of the MAF-MPU control scheme shown in FIG. 5 according to an embodiment of the present invention, where the numbers 1 through to 11 labeled in the small circles shown in FIG. 7 may represent Step S2-1 through to Step S2-11, respectively. For example, the requested memory space may be returned to the MRS after the secure world application stops execution by the follow steps:

(S2-1). The secure world application returns occupied memory space to SMM before stopping execution.
(S2-2). The secure world application is finished and returns control to the normal world application.
(S2-3). The normal world application sends a memory return request to the MRS to free the reserved MAF pages.
(S2-4). The MRS finds out the reserved MAF page numbers and sends “Remove Protection” message containing the reserved MAF page numbers to the MPS and waits for response.
(S2-5). After receiving the “Remove Protection” message, the MPS starts to check whether the MAF page numbers exist in the reservation list or not. If pages exist in the reservation list, the MPS removes the page numbers from the reservation list.
(S2-6). The MPS notifies SMM to remove the reserved memory space from the secure world memory pool.
(S2-7). The MPS starts to clean the memory contents of the reserved MAF pages.
(S2-8). The MPS modifies the page permission table and marks the reserved MAF pages as “no restriction”.
(S2-9). The MPS responses a success message to the MRS.
(S2-10). After receiving the success message, the MRS returns the reserved memory space to MM.
(S2-11). The MRS returns a success return code to the normal world application.

Please note that one of the processors shown around the upper left of FIG. 5 may be utilized for implementing the control circuit 120 shown in FIG. 1, and the control circuit 120 such as the aforementioned one of these processors may utilize the master side MAFs 112-1, 112-2, . . . , and 112-N1 such as the MAFs shown in FIG. 5 to selectively restrict data accessing activities of the bus master circuits 110-1, 110-2, . . . , and 110-N1 such as the processors, the crypto engine, and the video decoder shown in FIG. 5 through memory address filtering according to memory address filtering information. This is for illustrative purposes only, and is not meant to be a limitation of the present invention. According some embodiments, in addition to the aforementioned one of the processors shown around the upper left of FIG. 5, the control circuit 120 may further comprise the MPU shown in FIG. 5 (i.e. the memory protection unit), and may utilize the memory region filter table shown in FIG. 5 to selectively restrict data accessing activities of the bus master circuits 110-1, 110-2, . . . , and 110-N1 (e.g. the processors, the crypto engine, and the video decoder shown in FIG. 5) through memory address filtering according to the memory address filtering information in the memory region filter table.

According some embodiments, the page permission table shown in FIG. 4 may be integrated into the memory region filter table shown in FIG. 5, where the meanings of the plurality of sets of permission bits may vary (e.g. the permissions indicated by the plurality of sets of permission bits in the embodiment shown in FIG. 4 may be page permissions, and the permissions indicated by the plurality of sets of permission bits in these embodiments may be memory region permissions). For example, the control circuit 120 may comprise the MPU shown in FIG. 5, and each of the bus master circuits 110-1, 110-2, . . . , and 110-N1 such as that of the embodiment shown in FIG. 5 (e.g. the processors, the crypto engine, and the video decoder) still has capability of accessing data through the bus of the electronic device (e.g. the communications bus) in these embodiment. In addition, the control circuit 120 of these embodiments that comprises the MPU (which is positioned in the electronic device and coupled to the memory region filter table in the electronic device) is arranged for controlling secure memory allocation of the electronic device through maintaining the memory address filtering information for the memory region filter table, to restrict any unauthorized access to any portion of secure data within the electronic device, where the memory address filtering information of these embodiment may comprise the contents of the page permission table shown in FIG. 4 that is integrated into the memory region filter table, and the permissions indicated by the plurality of sets of permission bits may become section permissions. Examples of the section permissions may include, but not limited to, memory region permissions and page permissions. Additionally, with aid of the memory region filter table, the control circuit 120 of these embodiments that comprises the MPU is arranged for selectively restricting data accessing activities of the bus master circuits through memory address filtering according to the memory address filtering information. Further, the memory region filter table may comprise the plurality of sets of permission bits respectively corresponding to a plurality of sections of data, where each set of the plurality of sets of permission bits corresponds to the plurality of permission bit fields indicating different types of permission. For example, the plurality of sections of data may be a plurality of memory regions of data. In some examples, the plurality of sections of data may be the plurality of pages of data.

According to some embodiments, the MPU shown in FIG. 5 may be integrated into the control circuit 120. According to some embodiments, the memory region filter table shown in FIG. 5 may be integrated into the control circuit 120. According to some embodiments, the MPU and the memory region filter table shown in FIG. 5 may be integrated into the control circuit 120.

According to some embodiments, the memory region filter table shown in FIG. 5 and/or the master side MAFs 112-1, 112-2, . . . , and 112-N1 such as the MAFs shown in FIG. 5 may be integrated into the control circuit 120. For example, the memory region filter table shown in FIG. 5 and the master side MAFs 112-1, 112-2, . . . , and 112-N1 such as the MAFs shown in FIG. 5 may be utilized for filtering transactions on the bus. More particularly, the memory region filter table shown in FIG. 5 and the master side MAFs 112-1, 112-2, . . . , and 112-N1 such as the MAFs shown in FIG. 5 may be implemented with hardware circuits, and at least one processor in the electronic device and both of the memory region filter table shown in FIG. 5 and the master side MAFs 112-1, 112-2, . . . , and 112-N1 such as the MAFs shown in FIG. 5 may be integrated into the same module, which may be referred to as the control circuit 120 of these embodiments, where some program modules running on the at least one processor may control both of the memory region filter table shown in FIG. 5 and the master side MAFs 112-1, 112-2, . . . , and 112-N1 such as the MAFs shown in FIG. 5. This is for illustrative purposes only, and is not meant to be a limitation of the present invention. For example, the architecture for filtering bus transactions (i.e. transactions on the bus) may vary.

FIG. 8 illustrates a 2-stage MMU plus MAF plus MPU (2-stage-MMU-MAF-MPU) control scheme involved with the method 200 shown in FIG. 2 according to an embodiment of the present invention. The 2-stage-MMU-MAF-MPU control scheme is suitable for the processor supporting the 2-stage MMU, and the stage-two (stage2) page table (which can be taken as an example of the aforementioned at least one permission table) can only be configured by the normal world software program which is executed at the highest execution level (EL). The MMU treats the whole memory space as a series of fixed-size pages, and the concept may be similar to that of the MAFs, but the MMU page size (i.e. the page size of the MMU) might not be the same as that of the MAFs. In general, MMU page size may be 4 KB. In addition, the 2-stage MMU can perform 2 stages of memory address translations, where the MMU translates a virtual address to an intermediate address at stage-one (stage1) and translates the intermediate address to a physical address at stage2. The physical address is the address used in bus transactions. Based on the 2-stage-MMU-MAF-MPU control scheme, the apparatus 100 may replace the MAF functionality by stage2 MMU for all processors in the system, and other bus masters may still need MAFs to do the memory protection.

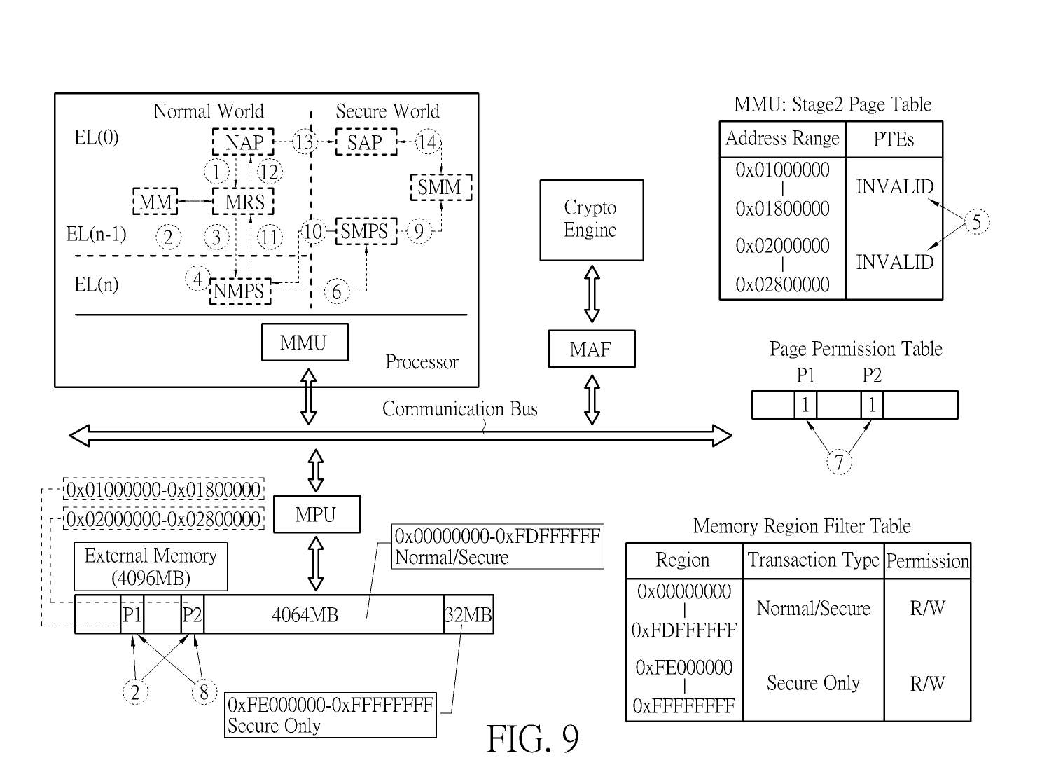

FIG. 9 illustrates a memory reservation flow of the 2-stage-MMU-MAF-MPU control scheme shown in FIG. 8 according to an embodiment of the present invention, where the numbers 1 through to 14 labeled in the small circles shown in FIG. 9 may represent Step S3-1 through to Step S3-14, respectively. For example, the external memory size of the system may be 4096 MB, the MMU stage1 page size and the stage2 page size are 4 KB, the MAF page size is 8 MB, and initially 32 MB memory space may be reserved for secure access only by configuring the MPU memory region filter table. When a secure world application needs 16 MB (which is equivalent to 2 MAF pages) memory spaces in addition to the 32 MB secure memory, the apparatus 100 may request memory space by the following steps:

(S3-1). The normal world application (NAP) sends a memory reservation request to the MRS to reserve 2 MAF pages in normal memory region.
(S3-2). After receiving the request, the MRS starts to request 2 available memory regions from the normal world memory management service (MM). The size of each available memory region is equal to a MAF page size.
(S3-3). The MRS sends “Add Protection” message containing the information (start address and size) of reserved memory regions to the normal world memory protection service (NMPS) and waits for response.
(S3-4). After receiving the “Add Protection” message, the NMPS starts to check whether the memory regions are valid or not. If valid, the NMPS keeps the memory regions information (the information of the memory regions) in the reservation list.
(S3-5). The NMPS marks the corresponding page table entries (PTEs) as invalid in the stage2 page table to prevent unauthorized access to reserved memory regions from normal world software programs which is executed at lower EL than that of the NMPS.
(S3-6). The NMPS passes the “Add Protection” message from the MRS to the SMPS and waits for response.
(S3-7). The SMPS calculates the MAF page numbers by the memory regions information contained in the message and then marks the MAF pages as “secure access only” in page permission table.
(S3-8). The SMPS starts to clean memory contents of the MAF pages.
(S3-9). The SMPS notifies the secure world memory management service (SMM) to add the reserved memory space to the secure world memory pool.
(S3-10). The SMPS responses a success message to the NMPS.
(S3-11). The NMPS responses a success message to the MRS.
(S3-12). After the MRS receives the success response message, it returns a success return code to the normal world application.
(S3-13). After the normal world application receives success return code, it starts to invoke the secure world application (SAP) to do the secure jobs.
(S3-14). The secure world application now can request memory from the SMM.

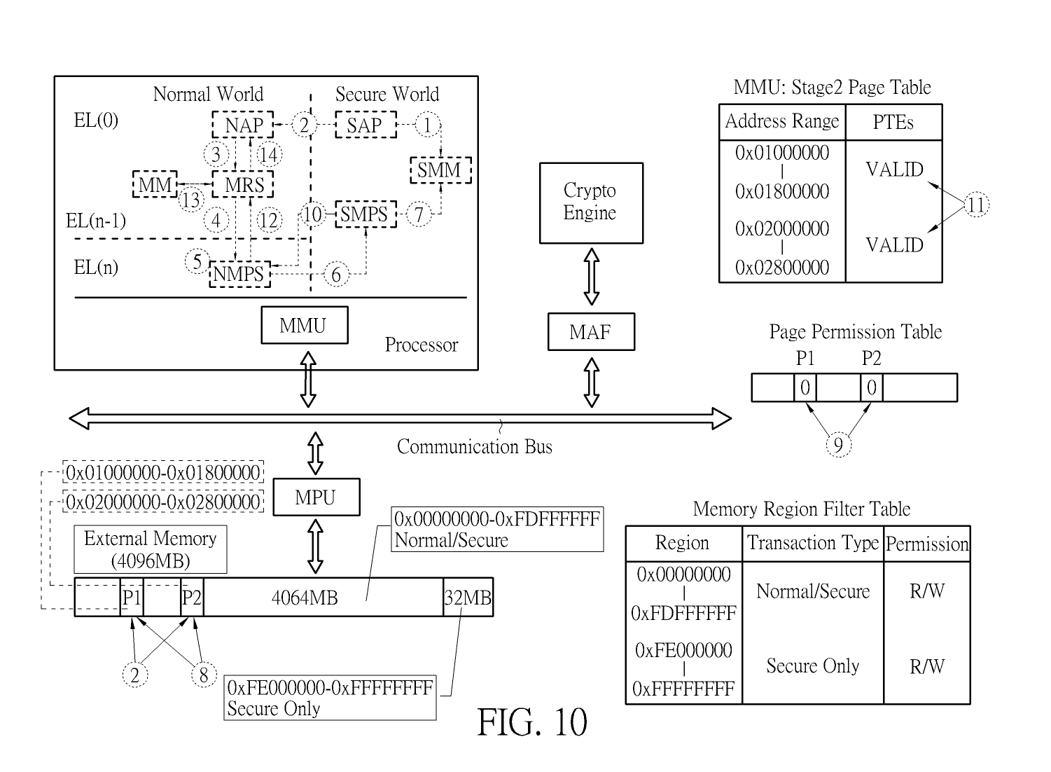

FIG. 10 illustrates a memory return flow of the 2-stage-MMU-MAF-MPU control scheme shown in FIG. 8 according to an embodiment of the present invention, where the numbers 1 through to 14 labeled in the small circles shown in FIG. 10 may represent Step S4-1 through to Step S4-14, respectively. For example, the requested memory space is returned to the MRS after the secure world application stops execution by the follow steps:

(S4-1). The secure world application returns occupied memory space to the SMM before stopping execution.
(S4-2). The secure world application is finished and returns to the normal world application.
(S4-3). The normal world application sends a memory return request to the MRS to free the reserved memory regions.
(S4-4). The MRS finds out the information of reserved memory regions and sends “Remove Protection” message containing the information to the NMPS and waits for response.
(S4-5). After receiving the “Remove Protection” message, the NMPS starts to check whether the reserved memory regions exist in the reservation list or not. If exist, the MPS removes the memory regions from the reservation list.
(S4-6). The NMPS passes the message from the MRS to the SMPS.
(S4-7). After receiving the message, the SMPS notifies the SMM to remove the reserved memory regions from the secure world memory pool.
(S4-8). The SMPS starts to clean the memory contents of the reserved memory regions.
(S4-9). The SMPS marks the reserved MAF pages as “no restriction” in page permission table.
(S4-10). The SMPS responses a success message to the NMPS.
(S4-11). The NMPS reconstructs the corresponding page table entries (PTEs) of the reserved memory regions and marks them as valid in the stage2 page table to enable access right of the reserved memory regions for the normal world software programs executed at lower EL than that of the NMPS.
(S4-12). The NMPS responses a success message to the MRS.
(S4-13). After receiving the success message, the MRS returns the reserved memory space to the MM.
(S4-14). The MRS returns a success return code to the normal world application.

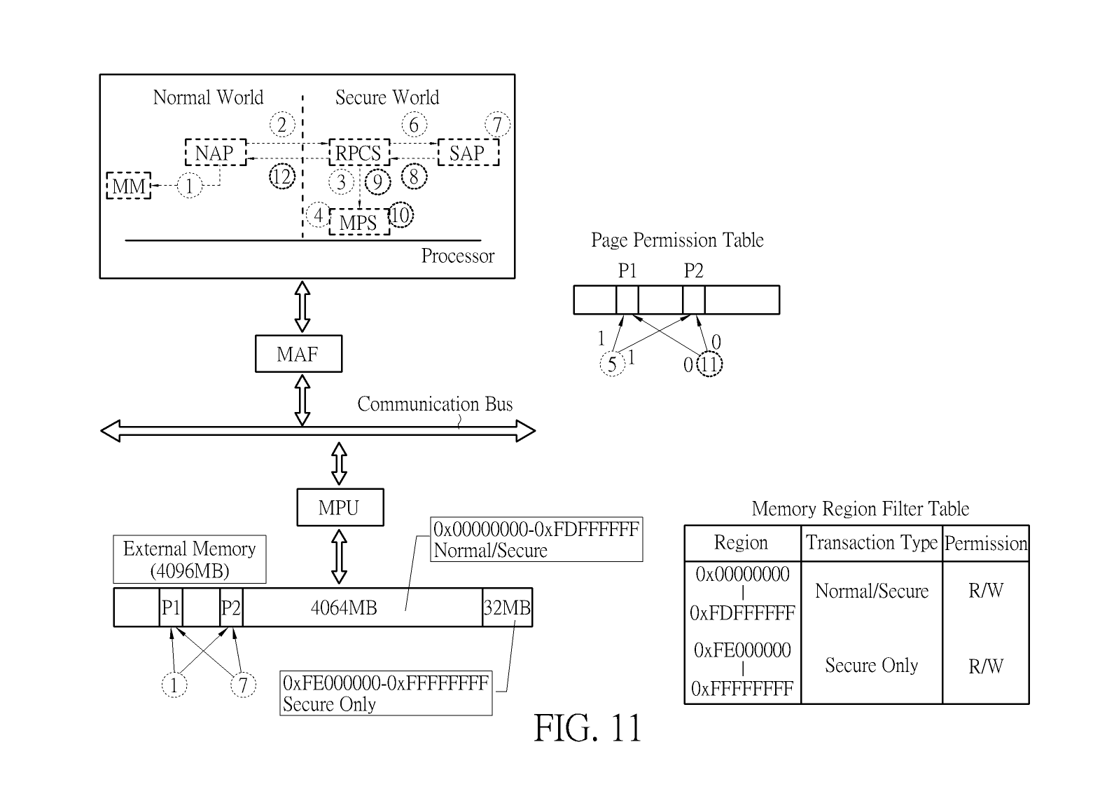

According to some embodiments, based on the architecture shown in FIG. 1, the apparatus 100 that operates according to the method 200 may perform fast data exchange between the normal world and the secure world. For example, by performing the aforementioned on-demand secure memory allocation, the apparatus 100 may accelerate the speed of data exchange between the NAP and the SAP. This may be implemented by using the same hardware architecture (such as that comprising the MAFs) but different software components and flow (s). In some embodiments, regarding the software components, the NAP may communicate with the SAP via a Remote Procedure Call (RPC) and exchange data by a shared memory region (SHM). A Remote Procedure Call Service (RPCS) is responsible for routing RPC messages and for exchanging data between the NAP and the SAP. Usually, the RPCS would not allow the SAP to directly access the data in the SHM since it can be accessed in the normal world and the data may be tampered by malicious software while the SAP is processing it. The RPCS will create a copy of input data in the secure memory instead. Similarly, the SAP will not output the artifact to the SHM, but in the secure memory. The output data will be copied to the SHM by the RPCS while the RPC call returns. This introduces 2 copies overhead per transaction. If the size of data to be exchanged is huge, it will impact the overall performance. In the following embodiments such as that shown in FIGS. 11-13, it is proposed to address this issue by slightly modifying operations of some previously described software flows such as that of the embodiments respectively shown in FIG. 6 and FIG. 7.

FIG. 11 illustrates a fast data exchange flow involved with the method 200 shown in FIG. 2 according to another embodiment of the present invention, where the numbers 1 through to 12 labeled in the small circles shown in FIG. 11 may represent Step S5-1 through to Step S5-12, respectively. For example, exchanging input and output data between the NAP and the SAP may be implemented by the follow steps:

(S5-1). The NAP sends a request to the MM to allocate 2 MAF pages in normal memory region. One is used for input buffer (P1), and the other is used for output buffer (P2). The NAP places data to be transferred to the SAP in the input buffer.
(S5-2). The NAP sends a request to the Remote Procedure Call Service (RPCS) containing the 2 MAF pages.
(S5-3). After received message, the RPCS tries to route the message to the SAP. But, before routing, it should protect the 2 MAF pages. The RPCS sends “Add Protection” message containing the 2 MAF page numbers to the MPS and waits for response.
(S5-4). After receiving the “Add Protection” message, the MPS starts to check whether the page number is valid or not. If valid, the MPS keeps the page numbers in the page reservation list.
(S5-5). The MPS modifies the page permission table and marks the MAF pages as “secure access only”.
(S5-6). The 2 MAF pages are protected. Now, the RPCS can route the message from the NAP to the SAP.
(S5-7). The SAP starts to read the data from P1 and put the result in P2.
(S5-8). After data processing is finished, the SAP sends a reply message to the RPCS.
(S5-9). The RPCS should “unlock” the 2 MAF pages before routing the reply message back to the NAP. It sends “Remove Protection” message containing the 2 MAF page numbers to the MPS and waits for a response.
(S5-10). After receiving the “Remove Protection” message, the MPS starts to check whether the MAF page numbers exist in the reservation list or not. If the MAF page numbers (which may represent the associated pages) exist in the reservation list, the MPS removes the page numbers from the reservation list.
(S5-11). The MPS modifies the page permission table and marks the reserved MAF pages as “no restriction”.
(S5-12). The RPCS routes the reply message to the NAP.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for performing secure memory allocation control in an electronic device, the apparatus comprising at least one portion of the electronic device, the apparatus comprising:
a control circuit, positioned in the electronic device and coupled to a plurality of master side memory address filters (MAFs) in the electronic device, arranged for controlling secure memory allocation of the electronic device through maintaining memory address filtering information for the master side MAFs, to make the master side MAFs restrict any unauthorized access to any portion of secure data within the electronic device;
wherein a plurality of bus master circuits in the electronic device are arranged for performing operations for the electronic device, and each of the bus master circuits has capability of accessing data through a bus of the electronic device; and
the master side MAFs are coupled between the bus and the bus master circuits, respectively, and are arranged for selectively restricting data accessing activities of the bus master circuits through memory address filtering according to the memory address filtering information.

2. The apparatus of claim 1, further comprising:
at least one permission table, coupled to the control circuit and the master side MAFs, arranged for providing the master side MAFs with the memory address filtering information for memory address filtering regarding the bus master circuits, respectively.

3. The apparatus of claim 2, wherein the master side MAFs selectively restrict the data accessing activities of the bus master circuits through memory address filtering based on the permission table, respectively.

4. The apparatus of claim 2, wherein the permission table indicates whether a plurality of memory regions of a memory of the electronic device are accessible.

5. The apparatus of claim 2, wherein the control circuit controls contents of the permission table for memory address filtering regarding the bus master circuits, respectively, wherein the contents of the permission table comprise the memory address filtering information.

6. The apparatus of claim 5, wherein the control circuit updates the contents of the permission table for memory address filtering regarding the bus master circuits, respectively.

7. The apparatus of claim 1, wherein the master side MAFs obtain the memory address filtering information from at least one permission table maintained by the control circuit, for memory address filtering regarding the bus master circuits, respectively.

8. The apparatus of claim 7, wherein according to the memory address filtering information, the master side MAFs determine whether an access to the portion of secure data is the unauthorized access to the portion of secure data.

9. The apparatus of claim 1, wherein the control circuit is integrated into one of the bus master circuits.

10. The apparatus of claim 9, wherein one or more of the bus master circuits is a processor of the electronic device.

11. A method for performing secure memory allocation control in an electronic device, the method comprising:
controlling secure memory allocation of the electronic device through maintaining memory address filtering information for a plurality of master side memory address filters (MAFs) in the electronic device, to make the master side MAFs restrict any unauthorized access to any portion of secure data within the electronic device;
wherein a plurality of bus master circuits in the electronic device are arranged for performing operations for the electronic device, and each of the bus master circuits has capability of accessing data through a bus of the electronic device; and
the master side MAFs are coupled between the bus and the bus master circuits, respectively, and are utilized for selectively restricting data accessing activities of the bus master circuits through memory address filtering according to the memory address filtering information.

12. The method of claim 1, further comprising:
utilizing at least one permission table to provide the master side MAFs with the memory address filtering information for memory address filtering regarding the bus master circuits, respectively.

13. The method of claim 12, wherein the master side MAFs selectively restrict the data accessing activities of the bus master circuits through memory address filtering based on the permission table, respectively.

14. The method of claim 12, wherein the permission table indicates whether a plurality of memory regions of a memory of the electronic device are accessible.

15. The method of claim 12, wherein the step of controlling secure memory allocation of the electronic device through maintaining the memory address filtering information for the master side MAFs to make the master side MAFs restrict the unauthorized access to the portion of secure data within the electronic device further comprises:
controlling contents of the permission table for memory address filtering regarding the bus master circuits, respectively, wherein the contents of the permission table comprise the memory address filtering information.

16. The method of claim 15, wherein the step of controlling secure memory allocation of the electronic device through maintaining the memory address filtering information for the master side MAFs to make the master side MAFs restrict the unauthorized access to the portion of secure data within the electronic device further comprises:
updating the contents of the permission table for memory address filtering regarding the bus master circuits, respectively.

17. The method of claim 11, wherein the step of controlling secure memory allocation of the electronic device through maintaining the memory address filtering information for the master side MAFs to make the master side MAFs restrict the unauthorized access to the portion of secure data within the electronic device is performed by utilizing a control circuit; and the master side MAFs obtain the memory address filtering information from at least one permission table maintained by the control circuit, for memory address filtering regarding the bus master circuits, respectively.

18. The method of claim 17, wherein according to the memory address filtering information, the master side MAFs determine whether an access to the portion of secure data is the unauthorized access to the portion of secure data.

19. The method of claim 11, wherein the step of controlling secure memory allocation of the electronic device through maintaining the memory address filtering information for the master side MAFs to make the master side MAFs restrict the unauthorized access to the portion of secure data within the electronic device is performed by utilizing a control circuit; the control circuit comprises a memory reservation service (MRS) module and a memory protection service (MPS) module; and the method further comprises:
utilizing the MRS module to reserve a plurality of memory regions in a normal memory world; and
utilizing the MPS module to reclaim at least one portion of the memory regions as secure memory regions in a secure memory world.

20. The method of claim 19, wherein the at least one portion of the memory regions is reclaimed as the secure memory regions by configuring at least one permission table.

21. An apparatus for performing secure memory allocation control in an electronic device, the apparatus comprising at least one portion of the electronic device, the apparatus comprising:
a control circuit, positioned in the electronic device and coupled to a memory region filter table in the electronic device, arranged for controlling secure memory allocation of the electronic device through maintaining memory address filtering information for the memory region filter table, to restrict any unauthorized access to any portion of secure data within the electronic device;
wherein a plurality of bus master circuits in the electronic device are arranged for performing operations for the electronic device, and each of the bus master circuits has capability of accessing data through a bus of the electronic device;
with aid of the memory region filter table, the control circuit is arranged for selectively restricting data accessing activities of the bus master circuits through memory address filtering according to the memory address filtering information; and
the memory region filter table comprises a plurality of sets of permission bits respectively corresponding to a plurality of sections of data, wherein each set of the plurality of sets of permission bits corresponds to a plurality of permission bit fields indicating different types of permission.
